(19) United States
(12) Patent Application Publication
(10) Pub. No.: US 2005/0219228 A1
(43) Pub. Date: Oct. 6, 2005

(54) Intuitive user interface and method

(75) Inventors: Rachid M. Alameh, Crystal Lake, IL (US); Mark W. Glenn, Hainesville, IL (US); Michael W. Schellinger, Arlington Heights, IL (US); Robert A. Zurek, Antioch, IL (US)

Correspondence Address: LAW OFFICES OF CHARLES W. BETHARDS, LLP, P.O. BOX 1622, COLLEYVILLE, TX, 76034, US

(73) Assignee: MOTOROLA, INC.

(21) Appl. No.: 11/015,566

(22) Filed: Dec. 17, 2004

Related U.S. Application Data
(63) Continuation-in-part of application No. 10/814,370, filed on Mar. 31, 2004.

(51) Int. Cl. G09G 5/00

(52) U.S. Cl. 345/173

(57) ABSTRACT

A user interface 103 for an electronic device 101 (and corresponding method) is arranged and constructed for intuitive control of interface functionality. The user interface includes: a user interface component, e.g. speaker, microphone, display backlighting, etc., that is one of a plurality of user interface components 105; interface circuitry 117 coupled to the user interface components 105; and a sensor 129 located in a position that is logically associated with, e.g. proximate to or co-located with, the user interface component and configured to provide an output signal when the sensor 129 is triggered, e.g. by proximity to a user, where the output signal facilitates, via for example a controller 143, a change in an operating mode of one or more of the user interface components 105.

### RELATED APPLICATIONS

This application is a continuation in part of and claims priority from U.S. patent application Ser. No. 10/814,370 titled METHOD AND APPARATUS FOR DETERMINING THE CONTEXT OF A DEVICE by Kotzin et al. filed on Mar. 31, 2004. The priority application is assigned to the same assignee as here and is hereby incorporated herein in its entirety.

### FIELD OF THE INVENTION

This invention relates in general to user interfaces and more particularly to intuitive user interfaces using sensors to enable various user interface functions.

### BACKGROUND OF THE INVENTION

Currently, many hand-held electronic devices, such as mobile telephones, personal digital assistants (PDAs) and the like, include extensive and sophisticated user interface functionality. Furthermore many of these devices are physically small with limited areas for conventional user controls, such as keys or buttons and corresponding switches that may be activated by a user in order to exercise aspects of the user interface. Practitioners in these instances have typically resorted to a menu driven system to control the user interface functions. Unfortunately, as additional features and flexibility is incorporated into these electronic devices, the menu system can become relatively complex with many levels. The end result is the user of the device can be presented with a bewildering, confusing and time-consuming process for activating or adjusting features or functions.

### BRIEF DESCRIPTION OF THE DRAWINGS

The various aspects, features and advantages of the present invention will become more fully apparent to those having ordinary skill in the art upon careful consideration of the following Detailed Description of the Drawings with the accompamying drawings described below.

FIG. 1 illustrates an exemplary block diagram of one embodiment of an device with an intuitive user interface.

FIG. 2 illustrates an exemplary block diagram of an alternative and in certain respects more detailed embodiment of an electronic device, i.e. a wireless communication device, with an intuitive user interface.

FIG. 3 illustrates an exemplary flow diagram of a method of facilitating intuitive control of user interface functionality for an electronic device.

FIG. 4 illustrates an exemplary electronic device having a sensor that is logically associated with a speaker as well as additional sensors for determining a context of the device.

FIG. 5 illustrates a further exemplary electronic device housing in a perspective view.

FIG. 6 is a cross section of an exemplary touch sensor.

FIG. 7 illustrates an exemplary capacitive touch sensor circuit diagram.

FIG. 8 is an exemplary back side of the electronic device.

FIG. 9 illustrates a cross sectional view of an exemplary speaker with an integral sensor surface.

FIG. 10 illustrates a cross sectional view of an exemplary microphone with an integral sensor surface.

### DETAILED DESCRIPTION

While the present invention is achievable by various forms of embodiment, there is shown in the drawings and described hereinafter present exemplary embodiments with the understanding that the present disclosure is to be considered an exemplification of the invention and is not intended to limit the invention to the specific embodiments contained herein. The invention is defined solely by the appended claims including any amendments made during the pendency of this application and all equivalents of those claims as issued.

As further discussed below various inventive concepts, principles or combinations thereof are advantageously employed to provide various methods and apparatus for creating an intuitive user interface for an electronic device, e.g. cellular phone or the like, or promoting intuitive control of an interface by a user. This is accomplished in various embodiments by providing a sensor that may be activated by a user, where the sensor is logically located relative to (or located so as to be logically related to) a user interface component feature, function, or functionality. For example, an operating mode or volume level of a speaker may be controlled or such control may be activated or initiated by user activation of a corresponding sensor(s) that is proximate to or co-located with the speaker or corresponding sound port(s). This intuitive control can be augmented by inputs, such as output signals from additional sensors that provide additional contextual input. For example, if the device is being held by the user rather than lying on another surface or the like as indicated by the inputs from additional sensors, the intuitive control of the volume level of the speaker can be further conditioned on these inputs. Sensors carried on the device, internally or externally, sense environmental or contextual characteristics of the device in relation to other objects or the user. The contextual characteristics may be static or dynamic.

It is further understood that the use of relational terms, if any, such as first and second, top and bottom, upper and lower and the like are used solely to distinguish one entity or action from another without necessarily requiring or implying any actual such relationship or order between such entities or actions. The terms “a” or “an” as used herein are defined as one or more than one. The term “plurality” as used herein is defined as two or more than two. The term “another” as used herein is defined as at least a second or more. The terms “including,” “having” and “has” as used herein are defined as comprising (i.e., open language). The term “coupled” as used herein is defined as connected, although not necessarily directly and not necessarily mechanically.

Some of the inventive functionality and inventive principles are best implemented or supported with or in software programs or instructions and integrated circuits (ICs) such as application specific ICs as well as physical structures. It is expected that one of ordinary skill, notwithstanding possibly significant effort and many design choices motivated by, for example, available time, current technology, and economic considerations, when guided by the concepts and principles disclosed herein will be readily capable of generating such software instructions, ICs, and physical structures with minimal experimentation. Therefore, in the interest of brevity and minimization of any risk of obscuring the principles and concepts according to the present invention, further discussion of such structures, software and ICs, if any, will be limited to the essentials with respect to the principles and concepts used by the exemplary embodiments

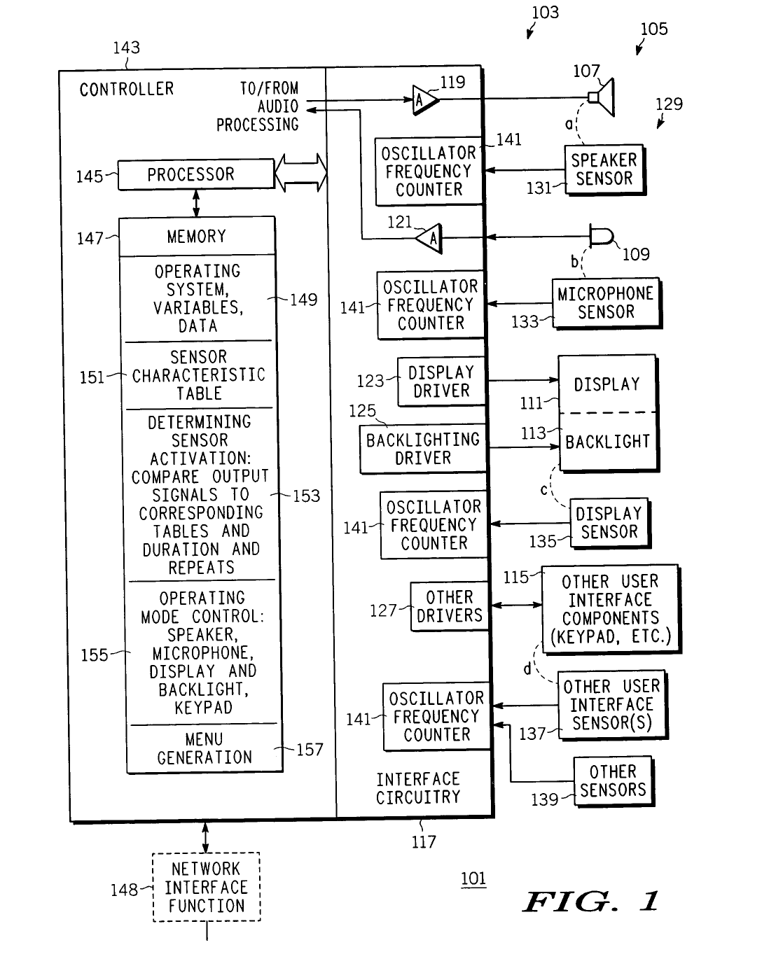

FIG. 1 illustrates an exemplary block diagram of one embodiment of an electronic device 101 arranged and configured with an intuitive user interface 103. The user interface can be arranged and constructed for intuitive control of certain aspects of interface functionality or various corresponding operational aspects. The user interface includes a plurality of user interface components, functions, or features 105, including, for example, a speaker 107, a microphone 109, a display 111 with backlighting 113, and other user interface components 115, such as a keypad and the like.

The user interface components, functions, or features 105 are normally coupled to interface circuitry 117 having one or more, respective interface circuits that are configured to process signals for or from (and couple signals to or from) the respective user interface component, function, or feature. For example the respective interface circuits include circuitry, such as an amplifier 119 for driving the speaker 107 or an amplifier 121 for amplifying signals, e.g. audio signals, from the microphone 109 where these amplifiers are further coupled from/to additional audio processing (vocoders, gates, etc.) as is known and as may vary depending on specifics of the electronic device 101. Other interface circuits include a display driver 123 for driving the display 111, a display backlighting driver 125 for driving and controlling levels, etc. for the display backlight 113, and other drivers 127 for supporting interfaces with other user interface components 115, such as a keyboard driver and decoder for the keyboard.

The intuitive user interface 103 further includes one or more sensors 129 that are located or physically placed in a position that is logically or intuitively associated with a respective user interface component, function, or feature. For example a logical or intuitive association can be formed when a sensor is proximate (physically near) to, co-located with, or located to correspond with functionality (e.g., sound ports or other visual indicia for a speaker or microphone) of the corresponding user interface component, function or feature. The sensors may be of varying known forms, such as pressure sensors, resistive sensors, or capacitive sensors with various inventive embodiments of the latter described below. The individual sensors form a sensor system that provides or facilitates an intuitive user interface.

In the exemplary embodiment shown in FIG. 1, the electronic device 101 with user interface 103 includes a sensor or speaker sensor 131 that is logically or intuitively associated with (or that logically corresponds to) the speaker 107 (reflected by dotted line a). Similarly sensor or microphone sensor 133 is logically or intuitively associated (dotted line b) with the microphone 109, sensor or display sensor 135 is associated (dotted line c) with the display 111 or backlight 113, and other user interface sensor(s) 137 are associated (dotted line d) with other user interface component(s) 115, such as a keypad, etc.

Note that each of these sensors 131, 133, 135, 137 is configured to provide an output signal (including a change in an output signal) when the sensor is triggered or activated by proximity to a user (including objects, such as a desk or a stylus, etc. used by a user) and this output signal facilitates changing an operating mode of the user interface component, function, or feature, e.g. speaker level, microphone muting or sensitivity, backlighting level, display contrast, and so forth. Additionally shown are other sensors 139 that may be used to determine the context of the electronic device as will be discussed further below. Note that different embodiments of electronic devices may have all or fewer or more sensors (or different sets of the sensors) than shown in FIG. 1. The individual sensors form a sensor system that provides or facilitates an intuitive user interface.

As reflected in the interface circuitry 117 of FIG. 1, each of the sensors 131, 133, 135, 137 is coupled to respective interface circuitry, depicted as an oscillator in combination with a frequency counter 141, such as can be used for capacitive sensors. Generally a capacitive sensor when proximate to an object with some conductivity, such as a human body part, e.g. a finger, acquires additional capacitance and this change in capacitance in turn changes, e.g. lowers, a frequency of the oscillator. The frequency of the oscillator can be determined by a frequency counter. Note that two or more of the sensors can use a common oscillator, rather than one oscillator per sensor as shown by FIG. 1. Furthermore, an oscillator for a given sensor or group of sensors can be located near one sensor with the corresponding frequency counter more distant. Additionally, all oscillators can be coupled to a common frequency counter and known multiplex techniques can be used to measure (from time to time or periodically) the frequency of the respective oscillators. Oscillator type sensor circuitry is one method of sensing capacitance change, and other circuitry can be substituted to sense capacitance change.

The interface circuitry 117 and respective circuits are coupled to a controller 143 that further includes a processor 145 inter-coupled to a memory 147 and possibly various other circuits and functions (not shown) that will be device specific. Note that all or part of the interface circuitry 117 may be included as part of (or considered as part of) the controller 143. The controller 143 can be further coupled to a network interface function 148, such as a transceiver for a wire line or wireless network. The processor 145 is generally known and can be microprocessor or digital signal processor based, using known microprocessors or the like. The memory 147 may be one or more generally known types of memory (RAM, ROM, etc.) and generally stores instructions and data that, when executed and utilized by the processor 145, support the functions of the controller 143.

A multiplicity of software routines, databases and the like will be stored in a typical memory for a controller 143. These include the operating system, variables, and data 149 that are high level software instructions that establish the overall operating procedures and processes for the controller 143, i.e. result in the electronic device 101 performing as expected. A table(s) of sensor characteristics 151 is shown that includes or stores expected parameters for sensor(s), such as a frequency range or time constant values and the like that can be used to determine whether a given sensor has been activated or triggered. Another software routine is a determining sensor activation routine 153 that facilitates comparing output signals from sensor(s) 131, 133, 135, 137, e.g. a frequency, to corresponding entries in the table 151. This routine also determines a duration of the sensor activation as well as parameters corresponding to repeated activations as needed. An operating mode control routine 155 provides for controlling operating modes of one or more of the user interface components, functions, or features, such as one or more of a speaker, microphone, display and display backlighting, keypad, and the like.

In operation, the device of FIG. 1 provides an intuitive user interface and thereby provides intuitive control of one or more user interface functions, components or features. For example, a user interface component or feature can be an earpiece or speaker 107 with a corresponding sensor or capacitive sensor 131 located proximate to or possibly co-located with the speaker 107. When a user activates or triggers the sensor 131 by, for example, touching it with a finger or the like the sensor or sensor system experiences a change in capacitance and thus changes in a frequency of an output signal from an oscillator. This change in frequency is determined or measured by the corresponding frequency counter 141 and an output signal representative thereof is coupled to the processor 145. The processor 145, using the determining sensor activation routine 153, compares the output signal from the frequency counter with the data in the sensor characteristics table 151 and decides, determines, or deduces that the sensor 131 has been activated or triggered, and in response executes an appropriate operating mode control routine 155.

Execution of the operating mode control routine 155 can result in a change in an operating mode of the speaker, e.g. an output level of the amplifier 119 and thus speaker. This can be accomplished by changing an input level to the amplifier, e.g. level from other audio processing circuits, or changing the gain of the amplifier 119 under direction of the processor 145, e.g. increasing/decreasing the level by 20 dB, muting the speaker, a 3 dB change in volume level, or the like. For example, the operating mode of the speaker can be changed from a private or earpiece mode to a loud speaker mode when, for example, the electronic device is a cellular phone and being used in a speaker phone mode. Note that other techniques can be implemented using the intuitive control and a logically associated sensor. For example, by distinguishing (or detecting) taps or multiple taps (momentary activations) relative to longer activations, e.g. based on a duration of the output signal from a sensor, the processor 145 can initiate a volume setting operation, e.g. by gradually increasing or decreasing volume levels possibly with an accompanying test tone or message or displayed message or the like.

Alternatively the processor can provide a menu, using the menu generation routine 157 and driving the display accordingly via the display driver 123. A user can then select from various options on the menu, e.g. volume up or down, mute, speaker phone, private, etc. The particulars of any given embodiment of the operating mode control routine 155 and resultant actions vis-a-vis the speaker are left to the practitioner and will depend on an assessment of user ergonomics and various other practicalities, e.g. what is a single tap versus double taps versus tap-and-hold, etc.

Execution of the operating mode control routine 155 can analogously result in a change of the operating mode of the microphone 109, e.g., muting (disabling the amplifier 121 or otherwise blocking the output from the amplifier 121) the microphone, changing the sensitivity of the microphone, possibly varying other microphone characteristics as may be required for example in going from a private mode to a speakerphone operating mode or alternatively bringing up a microphone related menu with choices for control of the microphone and its functions and features. Similarly, a backlighting level can be adjusted responsive to an output from the display sensor 135, a display 111 may be adjusted in terms of contrast level or enabled or disabled responsive to the display sensor 135 output, a keypad or other user interface components 115 may be enabled or disabled in response to other user interface sensors 137, or the like. For example, when a user interface component is a display 111, the interface circuitry 117 generally includes a display driver 123 or display backlighting driver 125, and the sensor 135 is located proximate to or integrated with the display 111. The display driver 123 or the backlighting driver 125 can be configured to be responsive to the output signal provided when the sensor 135 is activated or triggered. It is further noted that the change in one or more of the operating modes noted above can be further conditioned on output signals from the other sensors 139 in the sensor system.

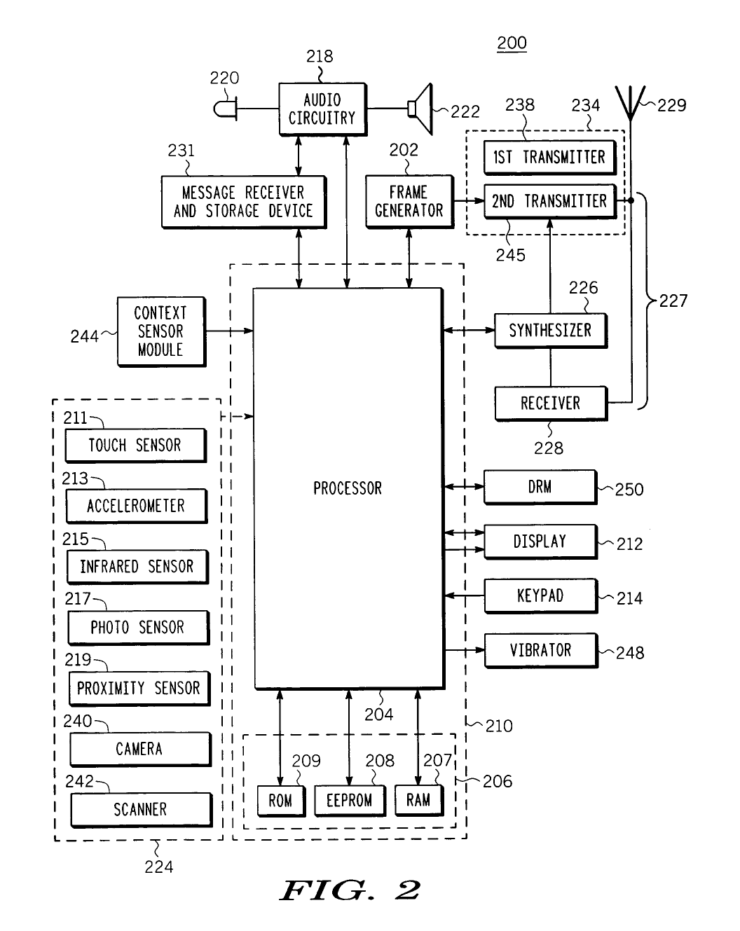

Turning to FIG. 2, a further embodiment of an exemplary electronic device 200 is shown in block diagram form. This exemplary embodiment is a cellular radiotelephone incorporating the present invention. However, it is to be understood that the present invention is not limited to a radiotelephone and may be utilized by other electronic devices including gaming device, electronic organizers, wireless communication devices such as paging devices, personal digital assistants, portable computing devices, and the like. In the exemplary embodiment a frame generator Application Specific Integrated Circuit (ASIC) 202, such as a CMOS ASIC and a microprocessor 204, combine to generate the necessary communication protocol for operating in a cellular system. The microprocessor 204 uses memory 206 such as RAM 207, EEPROM 208, and ROM 209, preferably consolidated in one package 210, to execute the steps necessary to generate the protocol and to perform other functions for the wireless communication device, such as writing to a display 212 or accepting information from a keypad 214. Information such as digital content may be received and stored in the memory 206 or it may be received and stored in a separate message receiver/storage device 231, such as a subscriber identity module (SIM) or other removable memory such as compact flash card, secure digital (SD) card, SmartMedia, memory stick, USB flash drive, PCMCIA or the like. The display 212 can be a liquid crystal display (LCD), a light emitting diode (LED) display, a plasma display, or any other means for displaying information. ASIC 202 can process audio transformed by audio circuitry 218 either from a microphone 220 or for a speaker 222.

A context sensor 224 is coupled to a processor or microprocessor 204. The context sensor 224 may be a single sensor or a plurality of sensors. In this exemplary embodiment, a touch sensor 211, accelerometer 213, infrared (IR) sensor 215, photo sensor 217, proximity sensor 219 make up together or in any combination the context sensor 224; all of which are all coupled to the microprocessor 204. Other context sensors, such as a camera 240, scanner 242, and microphone 220 and the like may be used as well, i.e. the above list is not an exhaustive but exemplary list. The device 200 may also have a vibrator 248 to provide haptic feedback to the user, or a heat generator (not shown), both of which are coupled to the microprocessor 204 directly or though an I/O driver (not shown).

The contextual or context sensor 224 is for sensing an environmental or contextual characteristic associated with the device 200 and sending the appropriate signals to the microprocessor 204. The microprocessor 204 takes all the input signals from each individual sensor and executes an algorithm which determines a device context depending on the combination of input signals and input signal levels. A context sensor module 244 may also perform the same function and may be coupled to the microprocessor 204 or embedded within the microprocessor 204. Optionally a proximity sensor 219 senses the proximity of a human body, e.g. hand, face, ear or the like and may condition intuitive user interface control on such proximity. The sensor may sense actual contact with another object or a second wireless communication device or at least close proximity therewith.

FIG. 2 also shows the optional transceiver 227 with a receiver circuitry 228 that is capable of receiving RF signals from at least one band or service and optionally more bands or services, as is required for operation of a multiple mode communication device. The receiver 228 may include a first receiver and a second receiver, or one receiver capable of receiving in two or more bandwidths. The receiver depending on the mode of operation, may be attuned to receive one or more of AMPS, GSM, CDMA, UMTS, WCDMA, Bluetooth, WLAN (such as 802.11) communication signals for example. Transmitter circuitry 234, is capable of transmitting RF signals in at least one bandwidth in accordance with the operation modes described above. The transmitter may also include a first transmitter 238 and second transmitter 245 to transmit on two different bandwidths or one transmitter that is capable of transmitting on at least two bands. Note that the transmitters and receivers are coupled to an antenna 229 as is known and tuned to various frequencies or bands via a synthesizer 226 as is known. Optionally, one of the transmitters and corresponding receivers may be capable of very low power transmissions for the transmission/reception of link establishment data to and from wireless local area networks. The first bandwidth or set of bandwidths is for communication with a communication system such as a cellular service provider. The second bandwidth or set of bandwidths is for point-to-point communication between two devices or a device and a WLAN.

A housing (not depicted) holds the transceiver 227 made up of the receiver 228 and the transmitter circuitry 234, the microprocessor 204, the contextual sensor 244, and the memory 206.

Still further in FIG. 2, a digital content management module 250, also known as a DRM agent, is coupled to the microprocessor 204, or is embodied as software stored in the memory and executable by the microprocessor 204. As noted, the context or contextual characteristic sensor 224 may be a single sensor or a system of sensors. The system of sensors may be sensors of the same or different types. For example the sensor 224 of the first device 200 may be a single motion sensor such as an accelerometer. For the embodiment illustrated in FIG. 2, an accelerometer or multiple accelerometers may be carried on the device to sense the orientation of the device 200. As those skilled in the art understand, other forms of motion and position detection may be used to sense the position of the device relative to its environment. Alternatively multiple types of sensors may be used to ensure the desired context is sensed in a repeatable manner. Other contextual sensors may be used in combination with the motion sensor, for example, to verify or validate a sensed contextual characteristic as discussed below.

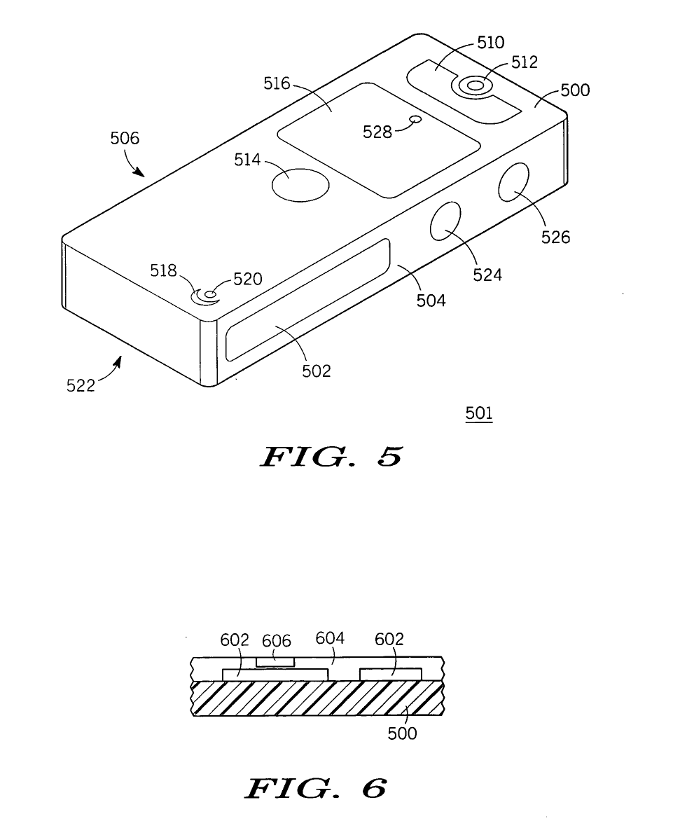

In yet another embodiment, the electronic device 200 may carry one or more sensors, such as a touch sensor (see FIG. 5). The touch sensor can be activated from the exterior of the housing 500 so that contact or close proximity by a foreign object, such as the user, activates the touch sensor. Activation of the touch sensor by the user or an object would initiate the desired or intuitively related operation, e.g. as previously described. The first device 200 may have a plurality of touch sensors carried at multiple independent locations on the housing 500 of the device. The locations may correspond to different sides of the device or to different user interfaces or portions thereof. The location of the touch sensors relative to the housing may also match points of contact by objects such as user's fingers and other parts of the body when the device 200 is held in predetermined positions. The touch sensors then determine when the device 200 is held in a certain common manner based on the touch information determined by the device.

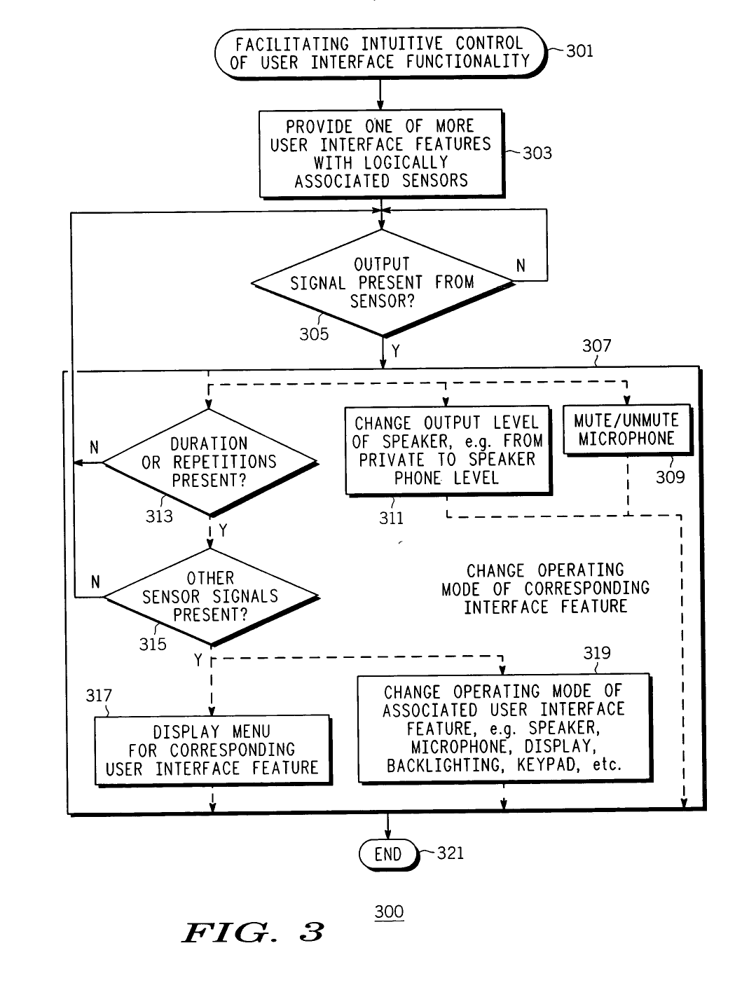

Referring to FIG. 3, an exemplary flow diagram of a method 300 of facilitating intuitive control of user interface functionality 301 for an electronic device will be discussed and described. Generally, the method 300 depicted can be advantageously implemented by the devices of FIG. 1 or FIG. 2 or other appropriately configured devices. Much of the discussions above with reference to FIG. 1 and FIG. 2 can be referred to here for various implementation details. Providing a user interface feature, e.g. speaker, microphone, display, display backlighting, keyboard, or the like, and a sensor located in a position that is logically associated with the user interface feature, e.g. proximate to, co-located with, or proximate to some indicia of functionality, where the user interface feature is included in a plurality of user interface features is shown at 303. At 305 determining whether an output signal is present that indicates activation of a sensor logically associated with a user interface component, function, or feature is performed. If no such output signal is present 305 is repeated as needed. If an appropriate output signal is present, the method 300 changes, responsive to the output signal, an operating mode of the corresponding user interface component, function, or feature 307.

As noted above, changing the operating mode 307 can take a multiplicity of forms, depending on the particular user interface component, function, or feature as well as a practitioner's preferences and possibly other sensor signals. Some examples are shown as alternatives in the more detailed diagrams making up 307. For example, where the user interface feature or component is a microphone and a sensor is located proximate to the microphone, the changing, responsive to the output signal, can further change an audio level 309 corresponding to the microphone, i.e. mute or unmute the microphone or otherwise vary the sensitivity thereof. Alternatively, where a speaker is provided together with a sensor located proximate to the speaker, the changing 307, responsive to the output signal, can include changing an output level 311 of the speaker, such as can be required when changing from a private, i.e. earpiece, mode to a loudspeaker, i.e. hands-free or speakerphone, mode of operation. The change from earpiece to hands-free mode can be an output level change to the same speaker or a switching of the signal from an earpiece speaker to a hands-free speaker. Similarly where the providing the user interface feature and the sensor includes providing a display and a sensor located proximate to or integrated with the display, the changing, responsive to the output signal, of the operating mode 307 may further enable the display, disable the display, change a display contrast level, or change (e.g., on/off or up/down) a backlighting level for the display (not depicted). For example, if the display is enabled, activation or triggering a proximate or integral sensor could disable or turn off the display.

One other example is shown that further exemplifies various alternative processes that may be performed as part of the processes at 307 or at 305. For example, the method 300 can determine whether the output signal duration or number of repetitions of the output signal satisfy some requirement 313 and if not, the method returns to 305. If so, a determination of whether other sensor signals are present 315, i.e. indicating the device is being held near a user's face or ear, can be performed where if the required other sensor signals are not present, the method returns to 305. If the conditions at 313 and 315 are satisfied, a menu can be displayed for the corresponding user interface feature 317 or a mode of operation can be changed 319 for an associated user interface feature, such as the speaker, microphone, display, display backlighting, keypad or the like. Note that none, either, or both 313 or 315 may be used as further conditional steps for any change in mode of operation. The method of FIG. 3 ends 321 after one or more of the processes at 307 are completed, but the method 300 can be repeated as needed, e.g. by returning to 305.

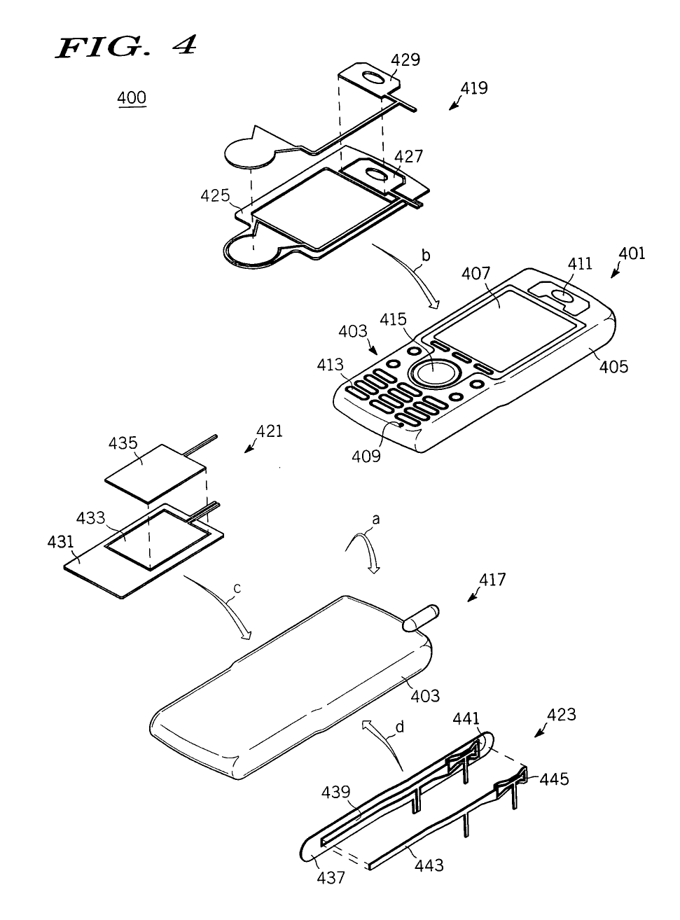

FIG. 4 illustrates an electronic device 400 having a sensor that is logically associated with a speaker as well as additional sensors for determining a context of the device. The electronic device of FIG. 4 is a cellular phone or handset that was fashioned to demonstrate one embodiment of various principles and concepts as discussed herein. A front perspective view 401 of the device with left side 403 and right side 405 illustrates a display 407, microphone 409 and speaker 411 ports, keypad 413 including thumbwheel key 415, and the like. A rear perspective view 417 (indicative of the device when rotated as indicated by arrow a) also shows the left hand side 403. The frontal view 401 shows a front sensor 419 disposed over the speaker or speaker ports 411 and the thumbwheel key 415 (depicted by arrow b). The rear view 417 shows a back sensor 421 disposed over a portion of the back of the device (depicted by arrow c) and a side sensor 423 disposed along the left side 403 of the device (depicted by arrow d).

Each of the sensors is a thin flexible layered structure, e.g. flex circuit, that includes a bottom conductive layer, e.g. copper or other conductive material, that in certain embodiments is fabricated to include a ground plane and a shield plate that is a separate structure that is non overlapping with the ground plane and that is driven (see FIG. 7 discussion below). In the center of the layered structure is an insulating or carrier layer, e.g. polyimide layer, that is not specifically depicted. On the top of the layered structure is another conductive layer, e.g. copper, that is fabricated to include one or more sensor plates that can be separate structures. Additional insulating layers, such as polyimide or paint, may be provided when needed to isolate the conductive plates or planes from other proximate conductive surfaces. The ground plane, shield plate and sensor plates each have a connector tab as depicted or other structure for coupling the respective plane or plate to other electrical circuitry, respectively, device ground, driving amplifier, and oscillator.

The front sensor 419 includes a ground plane 425, shield plate 427, and sensor plate 429 arranged and configured substantially as shown with respective connector tabs. The shield plate 427 shields the sensor plate from the interfering hardware. Each of the three connector tabs are electrically coupled via for example, a connector or other electrical contact to the appropriate circuitry (not shown). Note that the sensor plate 429 substantially overlaps or overlays the shield plate 427 and both are electrically isolated from the ground plane 425. The back sensor 421 includes a ground plane 431 and a shield plate 433 formed on the lower conductive layer and isolated from each other as depicted. The top layer includes a sensor plate 435 that overlaps the lower shield plate 433 and each of these structures includes a connector tab. The side sensor 423 includes a ground plane 437, a first and second shield plate 439, 441, and a first and second sensor plate 443, 445, respectively overlaying the shield plates. The first sensor plate 443 operates as the side sensor and the second sensor plate 445 may be used, for example, as a volume control or the like.

In practice these sensors would be attached to or integrated with a housing for the device, such as proximate to an inner surface of the housing. A user of the device can switch operating modes of, for example, the speaker by touching the front sensor near the speaker. This change in operating modes can be further conditioned on whether the device is being held in a user hand, e.g. based on output signals from the back sensor 421 and the side sensor 423. This change in the speaker operating mode can be further conditioned on an output signal from the front sensor 419 that corresponds to the front of the device being near the user's head, e.g. an output signal corresponding to the sensor overlaying the thumbwheel 415.

FIG. 5 illustrates an exemplary electronic device 501, such as the device 101 or 200, having a plurality of touch sensors carried on a housing 500. The housing 500 in this exemplary embodiment is adapted to be a handheld device and gripped comfortably by the user. A first touch sensor 502 of the plurality of touch sensors is carried on or disposed on a first side 504 of the device 101. A second touch sensor 506 (not shown) is carried on a second side of the housing 500. A third touch sensor 510 is carried on the housing 500 adjacent to a speaker port or speaker 512. A fourth touch sensor 514 is carried on the housing 500 adjacent to a display 516. A fifth touch sensor 518 is carried adjacent to a microphone port or microphone 520. A sixth touch sensor 522 is on the back of the housing (not shown). A seventh 524 and eighth 526 touch sensor are also on the first side 504. In the exemplary embodiment, the seventh 524 and eighth 526 touch sensors may, for example, control speaker volume or may be used to control movement of information displayed on the display 516.

The configuration or relative location of the eight touch sensors on the housing 500 a portion of which are included in the overall device context sensor allow the microprocessor 204 to determine for example how the housing 500 is held by the user or whether the housing 500 is placed on a surface in a particular manner. When the housing 500 is held by the user, a subset of touch sensors of the plurality of touch sensors are activated by contact with the users hand while the remainder are not. The particular subset of touch sensors that are activated correlate to the manner in which the user has gripped the housing 500. For example, if the user is gripping the device so as to make or initiate a telephone call, i.e. making contact with a subset of touch sensors) the first touch sensor 502 and the second touch sensor 506 will be activated in addition to the sixth touch sensor 522 on the back of the housing 500. The remaining touch sensors will typically not be active. Therefore, signals from three out-of-eight touch sensors are received, and in combination with each sensors known relative position, the software in the electronic device correlates the information to a predetermined grip. In particular, this touch sensor subset activation pattern can indicate that the user is holding the device in a phone mode with the display 516 facing the user.

In another exemplary embodiment, one touch sensor is electrically associated with a user interface component, function, or feature adjacent thereto. For example, the third touch sensor 510 which is adjacent to the speaker 512 is operative to control the speaker. Touching the area adjacent to the speaker may, for example, toggle the speaker on or off or cycle the speaker between two or more different operating modes. This provides intuitive interactive control and management of the electronic device operation.

The touch sensor in the exemplary embodiment is carried on the outside of the housing 500. A cross section illustrating the housing 500 and an exemplary touch sensor is shown in FIG. 6. The contact or touch sensor has conductive material 602 placed adjacent to the housing 500. It is not necessary that the conductive material be on the outside portion of the housing as shown in FIG. 6 as long as a capacitive circuit can be formed with an adjacent foreign object. The conductive material 602 may be selectively placed on the housing 500 in one or more locations as shown. In this exemplary embodiment, carbon is deposited on the housing 500 and the housing 500 is made of plastic. The carbon may be conductive or semi-conductive. The size of the conductive material 602 or carbon deposit can vary as shown and is normally dependant on the desired contact area to be effected by the touch sensor. For example, a touch sensor that is designed to sense the grip of a user's hand on the housing may be larger, i.e. have more surface area than a touch sensor designed to be used as a volume control. To protect the conductive material 602, a protective layer 604 is adjacent to the conductive material 602 layer. In this exemplary embodiment, the protective layer 604 is a paint coating applied over the conductive material 602. In this embodiment, a non-conductive paint is used to cover the carbon conductive material 602. Indicia 606 may be applied to the paint indicating where the touch sensor is located as this may not be determined with the painted surface.

Moving to FIG. 7, an exemplary capacitive or touch sensor circuit 700 is shown. In this exemplary embodiment a capacitance controlled oscillator circuit is used to sense contact with the touch sensor 701. The circuit 700 operates at a predetermined frequency when there is zero contact with the touch sensor 701. The circuit frequency lowers as a result of contact (or substantially adjacent proximity) made with the touch sensor 701. The touch sensor 701 has a sensor plate 702 made of the conductive material 602 (see FIG. 6). The sensor plate 702 is coupled to a first operational amplifier 704 such that the circuit 700 operates at the reference frequency which in this exemplary embodiment is nominally 200 kHz. In the exemplary touch sensor circuit 700, a ground plate 706 is placed adjacent to but not overlapping with the sensor plate 702. The ground plate 706 is insulated from the sensor plate 702. A shield plate 707 is disposed and substantially overlaps with but is isolated from the sensor plate 702. The shield plate 707 is isolated from and largely non-overlapping with the ground plate 706. The shield plate 707 is coupled to and driven by a second operational amplifier 708 which is coupled to a battery ground. The shield plate 707 is driven such that it is at the same potential as the sensor plate 702 to prevent a capacitance from being formed between the sensor plate 702 and the shield plate 707. The oscillator frequency is affected by the capacitance between the sensor plate and an object 709, e.g. human finger, etc., placed adjacent to the sensor plate 702. The oscillator frequency is inversely proportional to the capacitance value created by contact with the touch sensor. The greater the capacitance created by contact with the sensor plate 702, the greater the change in the oscillator frequency. Therefore, as the capacitance increases the oscillator circuit frequency decreases or changes toward zero. The change in frequency, i.e. drop or decrease from a nominal frequency, such as 200 kHz or other appropriate frequency, indicates that there is an object adjacent to the sensor plate and hence adjacent to the housing 500. The capacitance is a function of the size of the sensor plate 702 and the percent of the sensor plate 702 in contact with the object. As a result, the circuit frequency varies with the amount of coverage or contact with the sensor plate 702. Different frequencies of the circuit may therefore be assigned to different functions of the device 101. For example, touching a small portion of a touch sensor may increase the speaker volume to 50% volume and touching substantially all of the touch sensor may increase the speaker volume to 100% volume.

Turning back to FIG. 5, the exemplary housing 500 optionally includes an infrared (IR) sensor 528. In this exemplary embodiment, the IR sensor 528 is located on the housing 500 adjacent to the display 516, but may be located at other locations on the housing 500 as one skilled in the art will recognize. In this exemplary embodiment, the IR sensor 528 may sense proximity to other objects such as the user's body. In particular the IR sensor may sense how close the device or device display 516 is to the users face, for example. When the IR sensor 528 senses that the housing 500 is adjacent to an object, (e. g., the user's face) the electronic device 101, 200 may reduce the volume of the speaker to an appropriate level, e.g. a level appropriate for private mode.

In another embodiment, the output from the IR sensor 528 and the output from the plurality of touch sensors are used to determine the contextual environment of the device 101, 200. For example, as discussed above, the volume may be controlled by the sensed proximity of objects and in particular the users face. To ensure that the desired operation is carried out at the appropriate time (i.e. reducing the volume of the speaker to a level appropriate for private mode) additional contextual information may be used. For example, using the touch sensors 502, 506, 510, 514, 518, 522, 524 and 526 which are carried on the housing 500, the device may determine when the housing is being gripped by the user in a manner that would coincide with holding the housing 500 adjacent to the user's face. Therefore a combination of input signals sent to the microprocessor 204; one, or one set, from the subset of touch sensors and a signal from the IR sensor 528 representing the close proximity of on object (i.e. the user's head), may be required to change the speaker volume. The result of sensing the close proximity of an object may also depend on the current mode of the device 101, 200. For example, if the device is a radiotelephone, but not in a call, the volume would not be changed as a result of the sensed contextual characteristic. Similar concepts and principles are applicable to adjusting microphone sensitivity or other user interface features and functions.

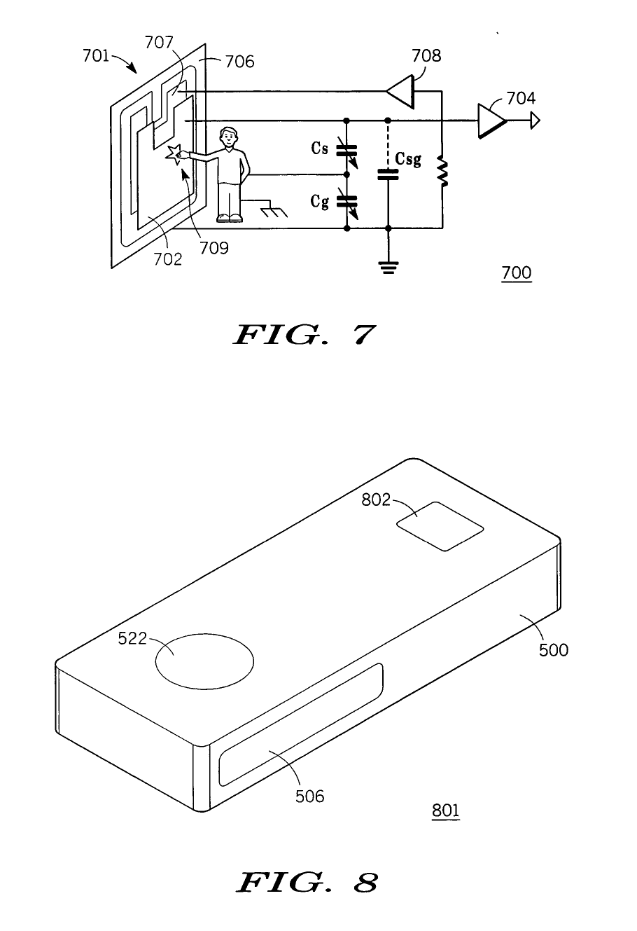

Similarly, a light sensor 802, as illustrated in FIG. 8, may be carried on the housing 500. In this exemplary embodiment, the light sensor 802 may sense the level of ambient light present. In this exemplary embodiment, when the device 801 is placed on the back housing, on a table for example, zero or little light could reach the light sensor 802. In this configuration, the sixth touch sensor 522 will also be activated if present on the device 801. The combination of the zero light reading and the activated sixth touch sensor 522 indicates to the device, through an algorithm and the microprocessor 204, that the device is on its back side. One skilled in the art will understand that this, and the combinations discussed above can indicate other configurations and contextual circumstances. The circumstances will determine which outcome or output function is desired as a result of the particular activated sensor combination. In general, the outcome or desired function which is most common with the context sensed by the devices 101, 200, 801 contextual sensors will be programmed and result as a output response to the sensed input. Thus the intuitive user interface component, function, or feature control can be further conditioned on other sensor signals. For example if a user's face activates or triggers a corresponding speaker sensor a volume level for the speaker will not be increased beyond a private mode level if other sensors indicate the device is being held by a user and close to a user's face.

Similar to the example discussed above concerning context changes resulting in the change in speaker volume, when the light sensor 802 reads substantially zero, the device 801 is assumed to be placed on its back in one exemplary embodiment such as on a table for example. In this exemplary embodiment, the device 801 could automatically configure to speakerphone mode with the volume adjusted accordingly. Another contextual characteristic would result from the light sensor sensing substantially zero light and the IR sensor sensing the close proximity of an object. This may indicate that the device is covered on both the front and back such as in the user's shirt pocket. When this contextual characteristic is sensed the device can change to a vibrate mode to indicate incoming calls, for example.

Other contextual sensors may be a microphone, a global positioning system receiver, temperature sensors or the like. The microphone may sense ambient noise to determine the device's environment. The ambient noise in combination with any of the other contextual characteristic sensors may be used to determine the device's context. As GPS technology is reduced in size and cost, the technology is implemented into more and more electronic devices. Having GPS reception capability provides location and motion information as another contextual characteristic. The temperature of the device 101, 200 may also be considered as a contextual characteristic either alone or in combination with any of the other contextual sensors of the device.

Other contextual characteristics that may be sensed by any combination of contextual sensors including those listed above, include the manner in which the device 101, 200 is held, the relation of the device to other objects, the motion of the device (including velocity and/or acceleration), temperature, mode, ambient light, received signal strength, transmission power, battery charge level, the number of base stations in range of the device, the number of internet access points as well as any other context related characteristics related to the device.

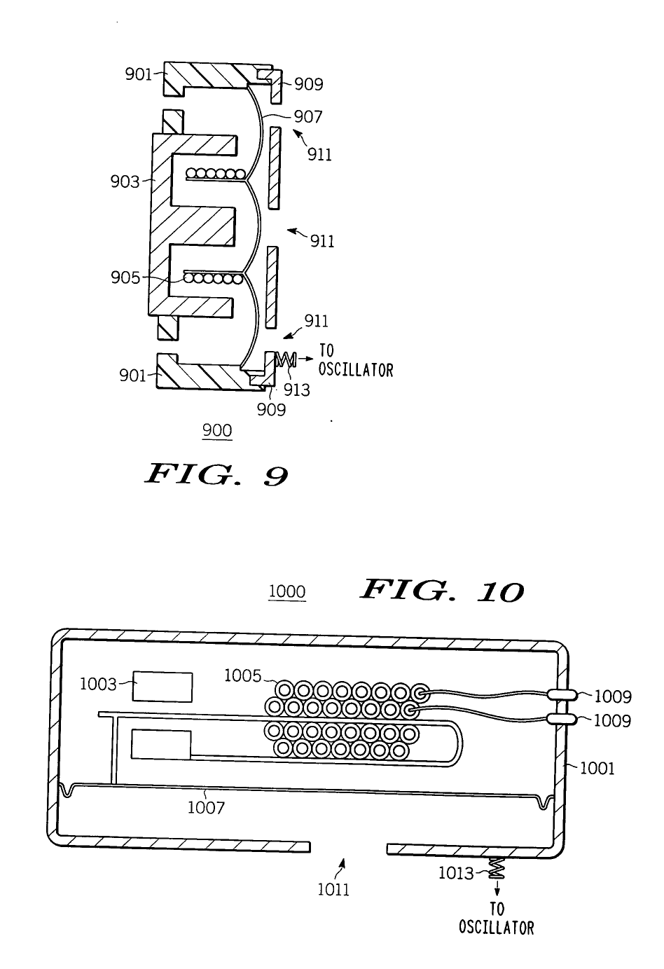

FIG. 9 illustrates a cross sectional view 900 of an exemplary speaker with an integral sensor surface. FIG. 9 shows a housing or insulating frame 901 that is typically made of a non-conducting material such as plastic. The housing or frame 901 is known and is arranged to hold a magnet or magnet assembly 903. A speaker coil 905 is driven with an audio signal from the amplifier 119 (see FIG. 1) via a connector (not shown) that is isolated from the magnet 903 and typically mounted to the housing. The coil 905 is mechanically mounted to a speaker diaphragm 907 that produces sound waves (when driven by the audio signal) that are ported via a metal front cover 909 and openings 911 therein.

When a logically associated sensor such as speaker sensor 131 shown in FIG. 1 is or includes a capacitive sensor, the metal front cover 909 can advantageously be used as a sensor plate, such as sensor plate 702 shown in FIG. 7 and thus the sensor is at least in part integral with the speaker. The capacitive sensor thus includes a conductive layer, e.g. the metal front cover 909, that is disposed in front of a diaphragm 907 for the speaker 900 and the conductive layer is mechanically attached to an insulating frame 901 for the speaker 900. The metal front cover 909 for the speaker 900 provides protection for the speaker diaphragm 907 as well as controls acoustic impedance corresponding to the speaker 900. A spring contact 913 is arranged and constructed to electrically couple the metal front cover 909 to an oscillator such as discussed with reference to FIG. 7. The spring contact 913 can be formed to be integral with a front housing for an electronic device such as the electronic device 101 shown in FIG. 1 or electronic device 200 shown in FIG. 2 or alternatively could be mounted to a corresponding circuit board within the electronic device.

FIG. 10 illustrates a cross sectional view of an exemplary microphone 1000 with an integral sensor surface. FIG. 10 shows a housing 1001 that is typically made of a conducting material such as metal and generally arranged to surround and protect all other elements of the microphone 1000. The housing 1001 (or frame) is known and is arranged to hold a magnet 1003 and a microphone coil 1005. The microphone coil 1005 is isolated from the magnet and is mechanically attached to a microphone diaphragm 1007. When the microphone diaphragm is driven by sound waves, such as a speaker's voice, etc., a corresponding electrical signal is provided at terminals 1009 and this signal will normally be coupled to an amplifier, such as amplifier 121 shown in FIG. 1. These terminals 1009 are insulated or electrically isolated from housing 1001. The sound waves are ported to the microphone diaphragm via openings or ports 1011 in the housing 1001.

When a logically associated sensor such as microphone sensor 133 shown in FIG. 1 is or includes a capacitive sensor, the housing 1001 can advantageously be used as a sensor plate such as sensor plate 702 shown in FIG. 7 and thus the sensor is at least in part integral with the microphone 1000. The capacitive sensor includes a conductive housing member including a portion disposed in front of a diaphragm 1007 of the microphone 1000. A spring contact 1013 is arranged and constructed to electrically couple the metal housing 1001 to an oscillator such as discussed with reference to FIG. 7. The spring contact 1013 can be formed to be integral with a front housing for an electronic device such as electronic device(s) 101, 200 or alternatively could be mounted to a corresponding circuit board within the electronic device. Note that the metal housing 1001 will need to be isolated from, for example, ground and thus an isolation layer may be required between the microphone 1000 or microphone cartridge and, for example, nearby printed circuit boards. Furthermore interference resulting from isolating the metal housing 1001 may have to be filtered from the electrical signal provided by the microphone. While a magnetic microphone arrangement has been described, it is noted that a piezoelectric or silicon microphone cartridge similarly packaged can be utilized.

It should also be noted that conductive portions of a typical display or display panel, such as a frame of such a panel (not specifically depicted) can be utilized as a portion of a sensor that is integral to the display in much the same manner as discussed above with reference to a speaker or microphone. A display including a touch sensor could use signals corresponding to the touch pad to enable or disable the display or to control backlighting levels between on and off or among a plurality of distinct levels.

Thus an electronic device, such as cellular phone or other communication device that includes a user interface that is arranged and constructed for intuitive control of interface functionality has been shown, described, and discussed. The user interface includes various embodiments having a plurality of user interface functions and features, such as one or more user audio/visual (AV) input/output (IO) features (one or more speakers, microphones, displays with display backlighting, keyboards, and the like). Further included are various and appropriate interface circuits coupled to the user AV I/O features and configured to couple signals to or from the user AV I/O features. To facilitate the intuitive control, a sensor, such as a capacitive sensor, is located in a position that is intuitively or logically associated with the user AV I/O feature or functionality thereof (proximate to, co-located with, or integral with) and configured to provide an output signal that changes when the sensor is triggered by proximity to a user or associated object. A processor, such as a microprocessor or dedicated integrated circuit or the like, is coupled to the output signal and configured to detect a change in the output signal and modify, responsive to the output signal or change thereto, an operating mode of the user AV I/O feature.

The electronic device including the intuitive user interface can be advantageously utilized to modify or change the operating mode of the user interface function, e.g. user AV I/O feature, in one or more intuitive manners, such as controlling or adjusting between different volume levels at a speaker, e.g. speaker phone level and private or earpiece level, muted and unmuted microphone modes, enabled and disabled display modes, various different backlighting levels for a display, or the like. For example, a user can merely touch the area of the speaker to switch between speaker phone and private modes, touch the microphone area to mute or unmute the microphone or adjust sensitivity, touch a particular portion of a keypad possibly in a particular way (for example two short taps and hold briefly) to enable the keypad rather than navigate a complex menu system or enter a lock code, or touch the display to adjust backlighting levels. The particular adjustments may be further conditioned on whether the user is holding the device, e.g. cellular phone, versus the device being disposed on another surface.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

1. A user interface for an electronic device, the user interface arranged and constructed for intuitive control of interface functionality and comprising:
a user interface component included in a plurality of user interface components;
an interface circuit coupled to the user interface component and configured to control more than one operating mode of the user interface component; and
a sensor located in a position that is logically associated with the user interface component and configured to provide an output signal to the interface circuit when the sensor is triggered by proximity to a user, the output signal facilitating a change in an operating mode of the user interface component.

2. The user interface according to claim 1, wherein the user interface component includes a speaker, the interface circuit includes an amplifier for driving the speaker, the sensor is located proximate to the speaker, and an output level of the amplifier is responsive to the output signal.

3. The user interface according to claim 2, wherein the sensor includes a capacitive sensor that is at least in part integral with the speaker.

4. The user interface according to claim 3, wherein the capacitive sensor includes a conductive layer disposed in front of a diaphragm for the speaker.

5. The user interface according to claim 4, wherein the conductive layer is mechanically attached to an insulating frame for the speaker.

6. The user interface according to claim 1, wherein the user interface component includes a microphone, the interface circuit includes an amplifier for amplifying signals from the microphone, the sensor is located proximate to the microphone, and the signals from the microphone are adjusted responsive to the output signal.

7. The user interface according to claim 6, wherein the sensor includes a capacitive sensor that is at least in part integral with the microphone.

8. The user interface according to claim 7, wherein the capacitive sensor includes a conductive housing member disposed in front of a diaphragm for the microphone.

9. The user interface according to claim 1, wherein the user interface component is a display, the interface circuit includes at least one of a display driver and display backlighting circuitry, the sensor is located proximate to the display, and at least one of the display driver and the display backlighting circuitry is responsive to the output signal.

10. The user interface according to claim 1, wherein the sensor comprises at least one of a capacitive sensor, a resistive sensor, and a pressure sensor.

11. The user interface according to claim 1, wherein the sensor is located in at least one of a position that is proximate to the user interface component and a position intuitively associated with functionality of the user interface component.

12. The user interface according to claim 1, wherein the user interface component is a speaker and wherein, when the sensor is triggered, a menu is provided on a display of the electronic device, the menu corresponding to functionality of the speaker.

13. The user interface according to claim 1, wherein the user interface component is a microphone and wherein, when the sensor is triggered, a menu is provided on a display of the electronic device, the menu corresponding to functionality of the microphone.

14. The user interface according to claim 1, wherein one or more additional sensors included with the electronic device provide one or more additional signals when triggered and the change in the operating mode of the user interface component is further conditioned on the one or more additional signals.

15. A method of facilitating intuitive control of user interface functionality for an electronic device, the method comprising:
providing a user interface feature and a sensor located in a position that is logically associated with the user interface feature, the user interface feature included in a plurality of user interface features;
determining whether an output signal from the sensor indicates activation of the sensor due to proximity to a user; and
changing, responsive to the output signal, an operating mode of the user interface feature.

16. The method according to claim 15, wherein the providing the user interface feature and the sensor further comprises providing a speaker and a sensor located proximate to the speaker, and wherein the changing, responsive to the output signal, further comprises changing an output level of the speaker.

17. The method according to claim 15, wherein the providing the user interface feature and the sensor further comprises providing a microphone and a sensor located proximate to the microphone, and the changing, responsive to the output signal, further comprises changing an audio level corresponding to the microphone.

18. The method according to claim 15, wherein the providing the user interface feature and the sensor further comprises providing a display with a display backlight and a sensor located proximate to the display, and the changing, responsive to the output signal, further comprises changing a backlighting level for the display.

19. The method according to claim 15, wherein the providing the user interface feature and the sensor further comprises providing a display and a sensor located proximate to the display, and the changing, responsive to the output signal, further comprises changing a display contrast level.

20. The method according to claim 15, wherein the changing, responsive to the output signal, an operating mode of the user interface feature further comprises providing a menu on a display that provides for changing the operating mode of the user interface feature.

21. The method according to claim 15, further comprising detecting one or more additional signals from one or more additional sensors and wherein the changing, responsive to the output signal, the operating mode is further responsive to the one or more additional signals.

22. The method according to claim 15, wherein the determining whether an output signal indicating activation of the sensor is present further comprises assessing a duration of the output signal.

23. The method according to claim 15, wherein the determining whether an output signal indicating activation of the sensor is present further comprises assessing repetitive occurrences of the output signal.

24. The method according to claim 15, wherein the providing the user interface feature and the sensor further comprises providing a speaker and a sensor located proximate to the speaker, and wherein the changing, responsive to the output signal, further comprises changing a selected operational speaker.

25. An electronic device including a user interface that is arranged and constructed for intuitive control of interface functionality and comprising:
a user audio/visual (AV) input/output (10) feature included in a plurality of user interface features;
an interface circuit coupled to the user AV I/O feature and configured to couple signals at least one of a) to the user AV I/O feature and b) from the user AV I/O feature;
a sensor located in a position that is intuitively associated with the user AV I/O feature and configured to provide an output signal that changes when the sensor is triggered by proximity to a user; and
a processor coupled to the output signal and configured to detect a change in the output signal and modify an operating mode of the user AV I/O feature.
